(19) United States
(12) Patent Application Publication
(10) Pub. No.: US 2020/0055170 A1
(43) Pub. Date: Feb. 20, 2020

(54) Non-Deforming Structure of Wrench in Manufacturing Process

(71) Applicant: Te-Chuan Yang, Taichung City (TW)

(72) Inventor: Te-Chuan Yang, Taichung City (TW)

(21) Appl. No.: 16/103,014

(22) Filed: Aug. 14, 2018

(51) Int. Cl. B25B 23/16; B21K 5/16; B25G 1/10

(52) U.S. Cl. CPC B25B 23/16; B25B 13/462; B25G 1/105; B21K 5/16

(57) ABSTRACT

A non-deforming structure of a wrench contains: a handle and at least one driving head arranged on at least one end of the handle. The handle includes an elongated body having four corners, a first length, a handle width, a handle thickness, and four elongated recesses. The handle width is 1.4 time to 2.6 time more than the handle thickness. Each elongated recess has a second length, a largest width, and a largest depth. Each of the largest width and the largest depth of each elongated recess shrinks from an intermediate portion thereof to two ends of each of the largest width and the largest depth until connects with each corner. The second length takes up at least ⅓ of the first length, the largest width takes up 2/9 to 4/9 of the handle width, and the largest depth takes up 2/9 to 4/9 of the handle thickness.

### BACKGROUND OF THE INVENTION

### Field of the Invention

The present invention relates to a wrench, and more particularly to a non-deforming structure of a wrench in a manufacturing process which is applied to rotate locking element, such as screw bolt or nut.

### Description of the Prior Art

A conventional wrench is one of important hand tools and is sorted into a fixed wrench or an adjustable wrench. For example, the fixed wrench contains a handle and at least one driving head arranged on at least end of the handle, and the handle is rotated so as to fasten or unfasten a screw bolt or a nut.

Referring to FIGS. 1-5, a conventional wrench 90 contains a handle 91 and two driving heads 92, wherein the handle 91 has a rectangular cross section and one-piece extending to form an elongated body. The two driving heads 92 are arranged on two ends of the handle 91 individually.

As manufacturing the conventional wrench 90, a billet A1 is hot forged at a predetermined high temperature and is pressed by a first mold B and a second mold C so that the billet A1 causes plastic deformation to produce a blocking 90A having the handle 91 and the two driving heads 92, and the blocking 90A also produces burrs (wastes) 901A therearound. Since the blocking 90A causes plastic deformation from a bar shape to a rectangle shape, multiple portions of the blocking 90A are pressed differently to have various reaction forces. The billet A1 is pressed upward and downward to deform horizontally, so a density of the billet A1 after being hot foraged is not uniform, and the handle 91 has concentrated stress vertically and horizontally to produce different deformation stresses on a central portion and two ends of the handle 91 of the blocking 90A, thus having actuate handle 91 of the blocking 90A. To overcome above-mentioned problem, the blocking 90A is stamped to reduce concentrated stress and to press the handle 91 of the blocking 90A, thus having straight handle 91. Thereafter, the burrs (wastes) 901A of the blocking 90A are trimmed, the blocking 90A is heat and surface treated, and the two driving heads 92 are machined, thus finishing the wrench 90.

However, the burrs (wastes) 901A are trimmed, and the blocking 90A is heat and surface treated after hot forging and stamping the blocking 90A, thus having complicated manufacturing, long manufacturing time, high manufacture cost, and high defect rate.

The present invention has arisen to mitigate and/or obviate the afore-described disadvantages.

### SUMMARY OF THE INVENTION

The primary objective of the present invention is to provide a non-deforming structure of a wrench in a manufacturing process which contains a handle including four elongated recesses extending along four corners from a central portion of the handle respectively so that a blocking having the handle is directly formed in a hot forging process to simplify manufacturing process, reduce manufacturing time and cost, and enhance product yield.

To obtain above-mentioned object, a non-deforming structure of a wrench in a manufacturing process provided by the present invention contains: a handle and at least one driving head.

The handle includes a rectangular cross section and one-piece extends to form an elongated body, the elongated body has four corners, and the handle including a first length, a handle width, and a handle thickness, wherein the handle width being 1.4 times to 2.6 times more than the handle thickness, the handle includes four elongated recesses extending along the four corners from a central portion of the handle respectively. Each of the four elongated recesses has a second length, a largest width, and a largest depth. Each of the largest width and the largest depth of each elongated recess shrinks from an intermediate portion thereof to two ends of each of the largest width and the largest depth until connects with each corner. The second length takes up at least ⅓ of the first length, the largest width takes up 2/9 to 4/9 of the handle width, and the largest depth takes up 2/9 to 4/9 of the handle thickness.

The at least one driving head is arranged on at least one end of the handle.

### BRIEF DESCRIPTION OF THE DRAWINGS

FIG. 1 is a perspective view of a blocking of a conventional wrench.

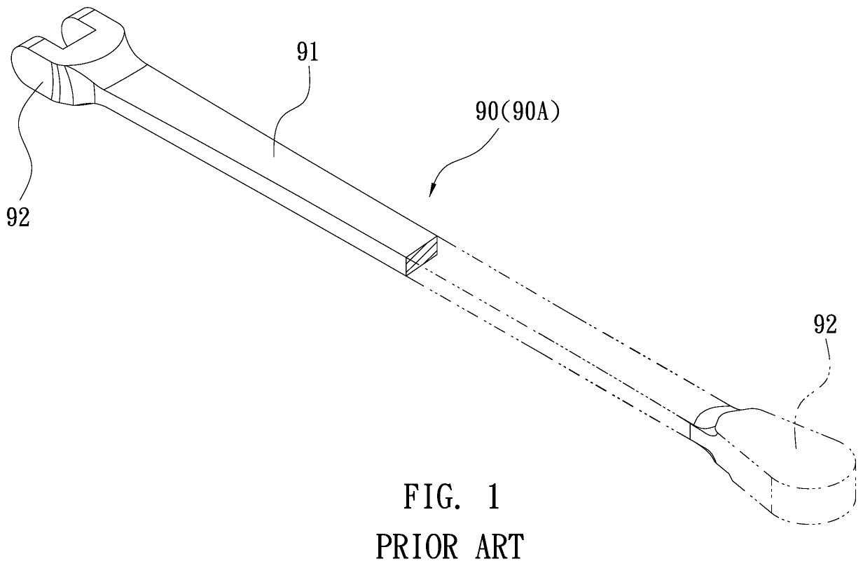

FIG. 2 is a perspective view showing the conventional wrench being hot forged.

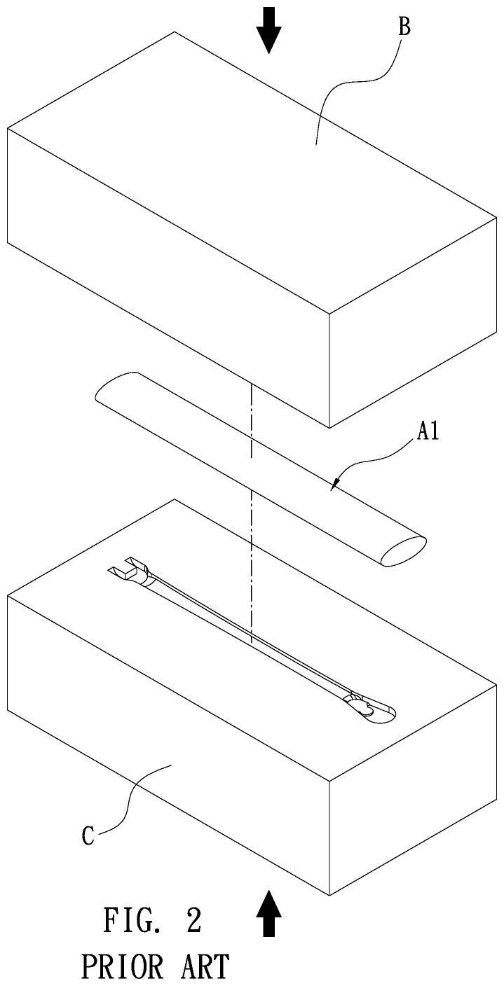

FIG. 3 is another perspective view showing the conventional wrench being hot forged.

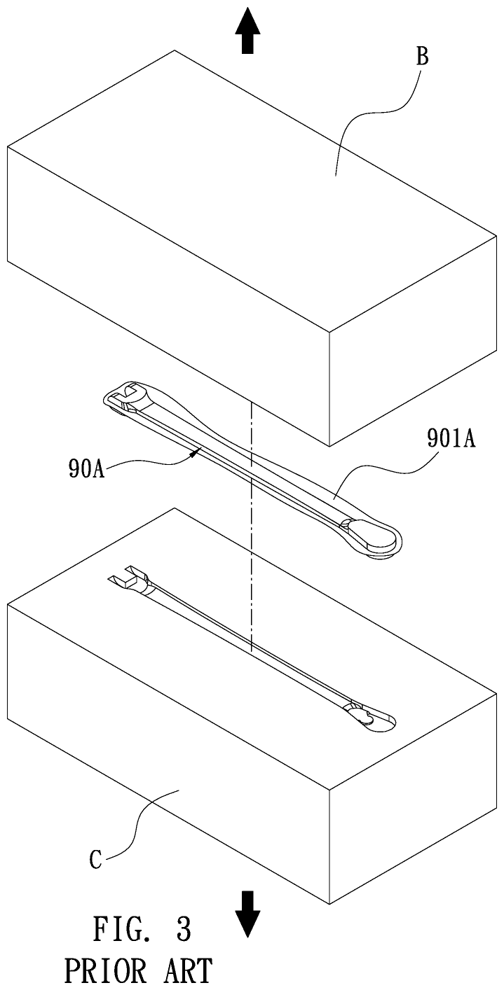

FIG. 4 is a perspective view showing the blocking of the conventional wrench being stamped into a straight shape from a curve shape.

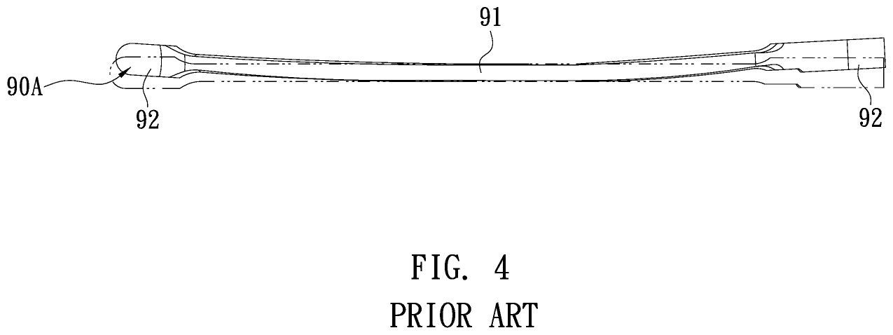

FIG. 5 is a cross sectional view showing the conventional wrench being stresses producing on the blocking having a handle in a hot forging process

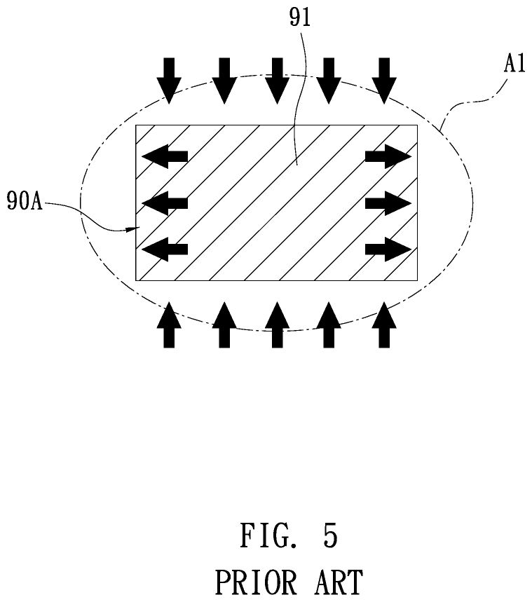

FIG. 6 is a cross-sectional perspective view showing the assembly of a blocking of a non-deforming structure of a wrench according to a preferred embodiment of the present invention.

FIG. 7 is a perspective view showing the wrench being hot forged according to the preferred embodiment of the present invention.

FIG. 8 is another perspective view showing the wrench being hot forged according to the preferred embodiment of the present invention.

FIG. 9 is a perspective view showing the assembly of a wrench according to the preferred embodiment of the present invention.

FIG. 10 is a side plane view showing the assembly of the wrench according to the preferred embodiment of the present invention.

FIG. 11 is a cross sectional view taken along the line A-A of FIG. 10.

FIG. 12 is a cross sectional view showing stresses producing on the blocking having a handle in a hot forging process.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

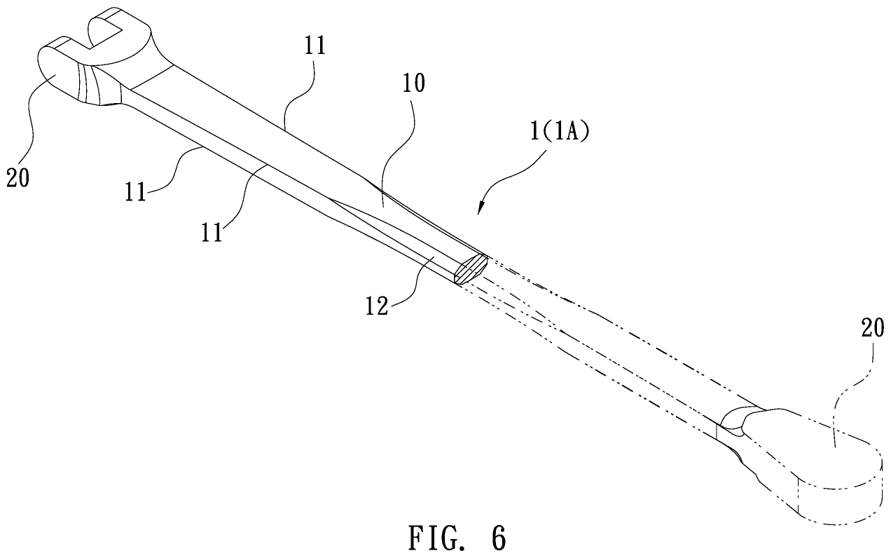

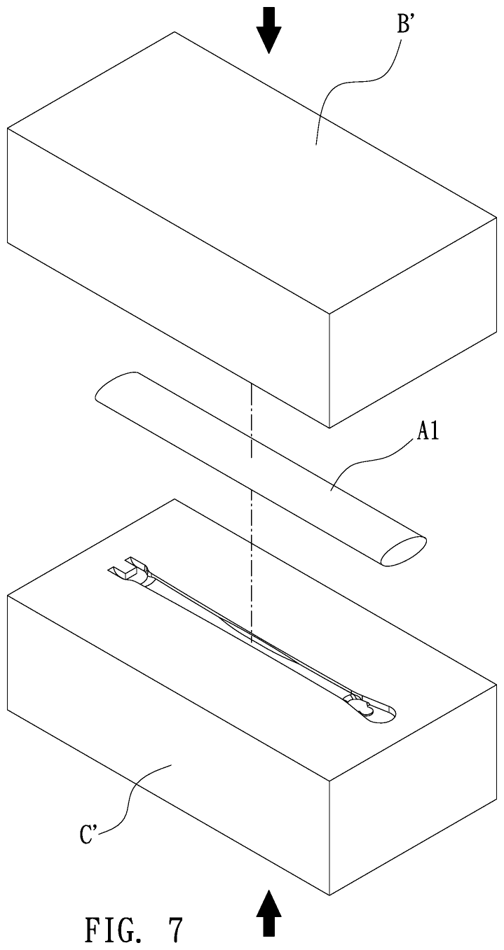

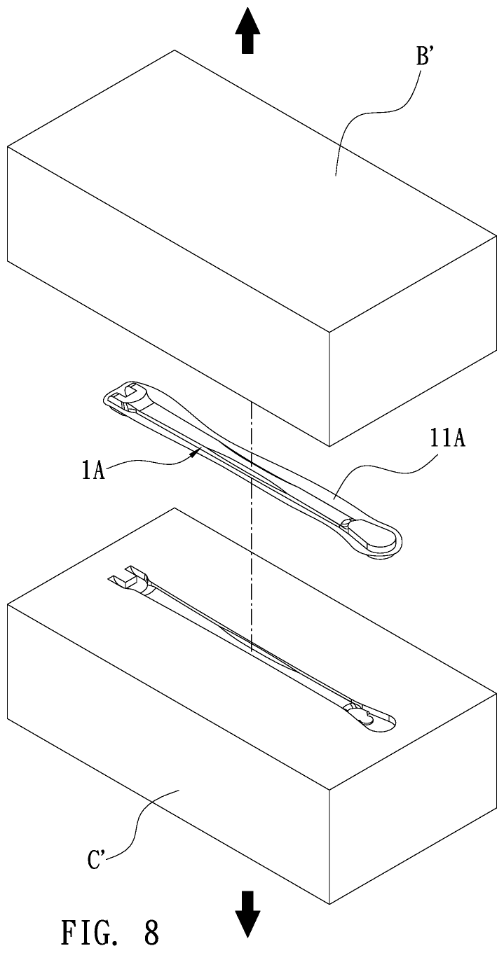

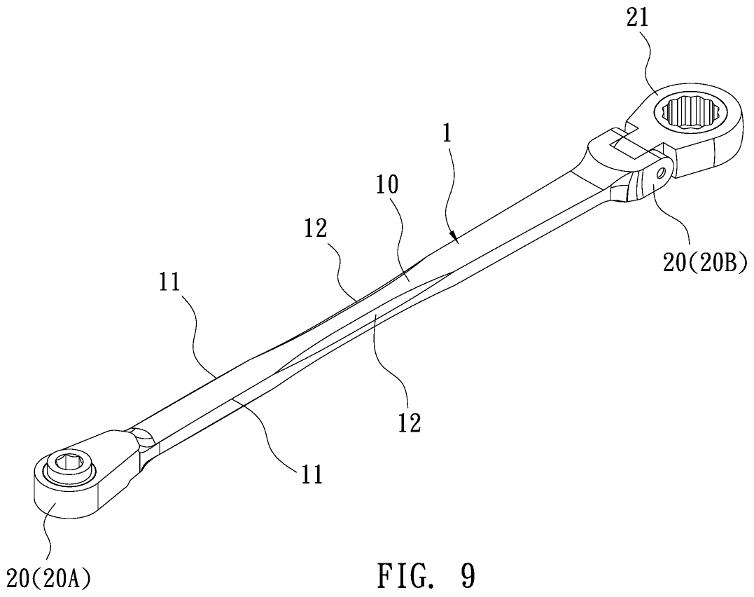

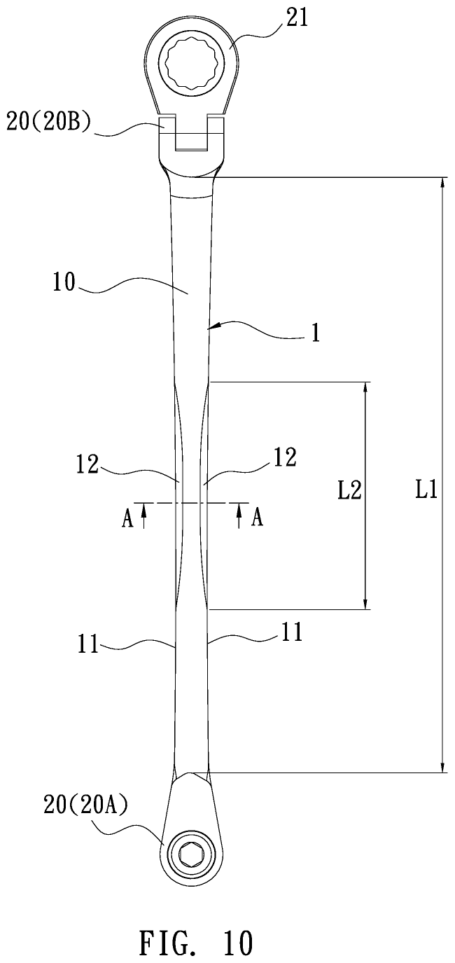

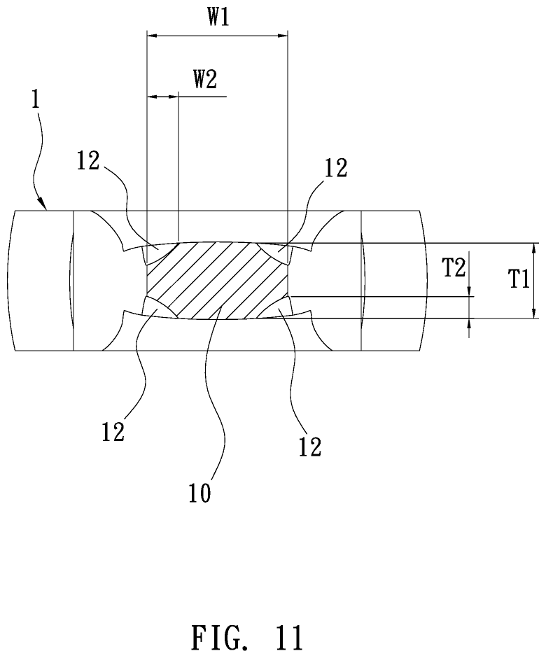

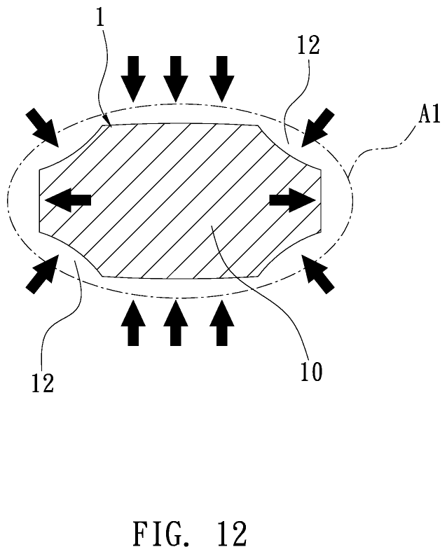

With reference to FIGS. 6-12, a non-deforming structure of a wrench 1 in a manufacturing process according to a preferred embodiment of the present invention comprises: a handle 10 and at least one driving head 20.

The handle 10 includes a rectangular cross section and one-piece extends to form an elongated body. The elongated body has four corners 11, and the handle 10 includes a first length L1, a handle width W1, and a handle thickness T1, wherein the handle width W1 is more than the handle thickness T1, for example, the handle width W1 is 1.4 times to 2.6 times more than the handle thickness T1 (in this embodiment, the handle width W1 is 1.8 times more than the handle thickness T1). The handle 10 includes four elongated recesses 12 extending along the four corners 11 from a central portion of the handle 10 respectively, wherein each of the four elongated recesses 12 has a second length L2, a largest width W2, and a largest depth T2. Each of the largest width W2 and the largest depth T2 of each elongated recess 12 shrinks from an intermediate portion thereof to two ends of each of the largest width W2 and the largest depth T2 until connects with each corner 11. Each elongated recess 12 has an arcuate bottom, the second length L2 takes up at least ⅓ of the first length L1. Preferably, each elongated recess 12 has the arcuate bottom, the second length L2 takes up ⅓ to 4/9 of the first length L1 (in this embodiment, the second length L2 takes up ⅓ of the first length L1). The largest width W2 takes up 2/9 to 4/9 of the handle width W1 (in this embodiment, the largest width W2 takes up ⅓ of the handle width W1). The largest depth T2 takes up 2/9 to 4/9 of the handle thickness T1 (in this embodiment, the largest depth T2 takes up ⅓ of the handle thickness T1).

The at least one driving head 20 is arranged on at least one end of the handle 10. In this embodiment, two driving heads 20 are one-piece formed on two ends of the handle 10 respectively, wherein one of the two driving heads 20 is a ratchet driving head 20A, and the other driving head 20 is an rotatable connection driving head 20B rotatably connected with an adjustable head 21. Furthermore, the wrench 1 is an open-end wrench, a box-end wrench, or other wrenches, etc.

As manufacturing the wrench 1, a billet A1 is heated at a predetermined high temperature in a hot forging manner and is pressed by a first mold B′ and a second mold C′ so that the billet A1 causes plastic deformation to form a blocking 1A having the handle 10 and the two driving heads 20, and the billet A1 also produces burrs (wastes) 11A therearound. The four elongated recesses 12 of the handle 10 offset vertical and horizontal deformation stresses of the central portion of the handle 10 in a hot forging process so that a density of the blocking 1A of the handle 10 is uniform and the blocking 1A is flat and smooth, and the burrs (wastes) 11A are trimmed. Thereafter, the blocking 1A is heat and surface treated so as to process the two driving heads 20, thus finishing the wrench 1.

The non-deforming structure of the wrench 1 of the present invention has advantages as follows:

1. The handle 10 of the non-deforming structure includes the four elongated recesses 12 extending along the four corners 11 from the central portion of the handle 10 respectively so that the blocking 1A having the handle 10 is directly formed in the hot forging process to simplify manufacturing process and to reduce manufacturing time and cost, because stamping the blocking 1A after the hot forging process in prior art is not required.

2. The blocking 1A having the handle 10 is hot forged directly so as to simplify manufacturing process and to enhance product yield.

While various embodiments in accordance with the present invention have been shown and described, it is clear to those skilled in the art that further embodiments may be made without departing from the scope of the present invention.

What is claimed is:

1. A non-deforming structure of a wrench in a manufacturing process comprising:
a handle including a rectangular cross section and one-piece extending to form an elongated body, the elongated body having four corners, and the handle including a first length, a handle width, and a handle thickness, wherein the handle width being 1.4 times to 2.6 times more than the handle thickness, the handle includes four elongated recesses extending along the four corners from a central portion of the handle respectively, wherein each of the four elongated recesses has a second length, a largest width, and a largest depth, each of the largest width and the largest depth of each elongated recess shrinks from an intermediate portion thereof to two ends of each of the largest width and the largest depth until connects with each corner, the second length takes up at least ⅓ of the first length, the largest width takes up 2/9 to 4/9 of the handle width, and the largest depth takes up 2/9 to 4/9 of the handle thickness; and
at least one driving head arranged on at least one end of the handle.

2. The non-deforming structure as claimed in claim 1, wherein each elongated recess has an arcuate bottom.

3. The non-deforming structure as claimed in claim 1, wherein two driving heads are one-piece formed on two ends of the handle respectively.

4. The non-deforming structure as claimed in claim 1, wherein the second length takes up ⅓ to 4/9 of the first length.
